(19) United States
(12) Patent Application Publication
(10) Pub. No.: US 2022/0227455 A1
(43) Pub. Date: Jul. 21, 2022

(54) INTER-BICYCLE COMMUNICATION FOR COMMUNAL BIKING EXPERIENCES

(71) Applicant: Weel Autonomy Inc., Walnut, CA (US)

(72) Inventors: Justin Allan Corbett, Bothell, WA (US); David Carlyle Hansen, Mercer Island, WA (US); Dylan Eugene Meehan, Seattle, WA (US); Matthew William Sheen, Seattle, WA (US)

(21) Appl. No.: 17/574,946

(22) Filed: Jan. 13, 2022

Related U.S. Application Data
(60) Provisional application No. 63/138,213, filed on Jan. 15, 2021.

(51) Int. Cl. B62M 6/50; H04W 4/40; B62J 45/412; B62J 45/411; B62J 45/20

(52) U.S. Cl. CPC B62M 6/50; H04W 4/40; B62J 45/20; B62J 45/411; B62J 45/412

(57) ABSTRACT

Electronic bicycles may communicate with each other to provide a communal biking experience to their riders. The electronic bicycles may collect rider data about their riders and may adjust the output parameters of the electronic bicycles based on the rider data. For example, the electronic bicycles may identify a weaker rider of the riders and may adjust the output parameters of the weaker rider's electronic bicycle to minimize a difference in the operation of the weaker rider's electronic bicycle and the stronger rider's electronic bicycle. Additionally, a parent rider may establish rider restrictions on an electronic bicycle ridden by a child.

### CROSS-REFERENCE TO RELATED APPLICATIONS

This application claims priority to U.S. Provisional Patent Application No. 63/138,213, filed Jan. 15, 2021 and entitled “Electronically Controlled Exercise Bike,” the contents of which are hereby incorporated by reference.

### BACKGROUND

Bicycle riders often enjoy riding their bicycles with their friends and family as a method of socializing and communal exercise. However, riders that want to ride with their friends and family may experience difficulty determining routes that provide a sufficient workout for all of the riders involved. This issue arises when riders who want to socialize are not of the same skill level or fitness level. For example, one rider may be friends with another rider, however the first rider may be more fit than the second rider. Thus, a route that would provide a sufficient workout for the first rider may be too difficult for the second rider. This introduces a tradeoff where riders are required to balance exercising on their bicycles with socializing on their bicycles.

Additionally, parents may have concerns about riding bicycles with their children when their children are young and inexperienced. For example, parents may be concerned that their child's inexperience could cause the child to lose control of their bicycle and crash. Additionally, parents may not trust their child's judgment and may want to ensure that the child does not ride too quickly or too far away from the parent. However, when a child is alone on a bicycle, the child is often capable of operating the bicycle however they want without a parent's ability to exercise real-time control over the child's operation of the bicycle. Thus, parents may be reluctant to ride on bicycles with their children.

### SUMMARY

Electronic bicycles may communicate with each other and coordinate to provide a communal biking experience for riders of the electronic bicycles. The electronic bicycles may establish a communicative connection with each other over a network. For example, the electronic bicycles may communicate over the Internet or may communicate directly through a Bluetooth connection. The electronic bicycles may collect rider data describing the operation of the electronic bicycles by the riders. For example, the rider data may include the rate at which the rider is pedaling, the speed of the electronic bicycle, or the virtual resistance imparted by the pedals. The electronic bicycles may then adjust the output parameters of the electronic bicycles based on the collected rider data. The output parameters for an electronic bicycle are parameters that control how an input from a user is translated into an output by the electronic bicycle. For example, the output parameters may include a virtual resistance imparted by the pedals, a virtual gear ratio, or a power output provided to wheel hub motors that provide a torque to the wheels.

The electronic bicycles may adjust the output parameters of the electronic bicycles by generating output adjustments for the output parameters. The output adjustments may increase or decrease output parameters. For example, the output adjustments may increase or decrease virtual resistance imparted by the pedals, a virtual gear ratio, or the power output of the electronic bicycle. The output adjustments also may activate, deactivate, or control features of the electronic bicycle. For example, the output adjustments may control steering assistance features of the electronic bicycle.

In some embodiments, the electronic bicycles identify a weaker rider, and adjust the output parameters of the electronic bicycle of the weaker rider to make the weaker rider's operation of their electronic bicycle more similar to that of the stronger rider. For example, the electronic bicycles may receive rider data from the riders and may identify one of the riders as a weaker rider. For example, the electronic bicycle may determine which rider has a lower overall pedal rate or which rider selects a lower virtual resistance to identify the weaker rider. The electronic bicycles may then generate output parameters so to minimize the difference in the riders' operation of their electronic bicycles. For example, the electronic bicycles may increase the power output of the weaker rider's electronic bicycle so that it is closer to the power output of the stronger rider's electronic bicycle. By adjusting the output parameters of the weaker rider's electronic bicycle, the electronic bicycles allow the weaker rider to have a communal biking experience with a stronger rider on the same route while ensuring that the route is not too difficult for the weaker rider. This allows riders to have communal biking experiences with other riders with different skill levels to their own.

In some embodiments, the electronic bicycles adjust the output parameters enforce rider restrictions that have been imposed on one of the electronic bicycles. For example, a parent rider on one electronic bicycle may impose rider restrictions on an electronic bicycle ridden by a child rider. The rider restrictions are restrictions or limitations that a rider can place on the operation of an electronic bicycle. For example, the rider restrictions may impose a maximum speed that the electronic bicycle can achieve or may establish a geographic area within which the electronic bicycle must remain. The rider restrictions on an electronic bicycle may be dependent on the rider data from another electronic bicycle. For example, the rider restrictions may impose a maximum distance that the electronic bicycle can travel from another electronic bicycle or may limit the speed of the electronic bicycle to the speed of the other electronic bicycle. By automatically adjusting output parameters of an electronic bicycle to enforce rider restrictions imposed on that electronic bicycle, a parent rider can feel more secure that a child rider will not engage in dangerous behavior while riding an electronic bicycle. Thus, parent riders imposing rider restrictions on an electronic bicycle operated by there are more likely to ride their bicycle with their child.

### BRIEF DESCRIPTION OF THE DRAWINGS

FIG. 1 illustrates example hardware components of an example autonomous electronic bicycle, in accordance with an embodiment.

FIG. 2 is a block diagram of an environment in which an autonomous electronic bicycle operates, in accordance with an embodiment.

FIG. 3 illustrates electronic bicycles communicating to provide a communal biking experience for their riders, in accordance with some embodiments.

FIG. 4 is a flowchart illustrating an example method for adjusting output parameters of a weaker rider's electronic bicycle, in accordance with some embodiments.

FIG. 5 is a flowchart illustrating an example method for enforcing rider restrictions on an electronic bicycle, in accordance with some embodiments.

### DETAILED DESCRIPTION

Electronic Bicycle Hardware

An electronic bicycle can be any bicycle in which some or all torque provided to the wheels is provided by an electronic motor (or similar propulsion system). When operated by a rider, the output torque to the wheels can be based on an input power exerted by the rider on pedals of the electronic bicycle (e.g., based on a signal produced by pedals representative of a cadence of pedaling, a speed of pedaling, or a strength of pedaling by the rider). In some embodiments, an electronic bicycle is an autonomous two-wheeled vehicle capable of operating autonomously without a rider. However, an electronic bicycle can be ridden by a rider as a traditional (non-autonomous) bicycle with or without electronic assistance, according to some embodiments. In some implementations, an electronic bicycle is “autonomous capable,” that is, able to operate both in “autonomous mode” without a rider or direct rider control and in “manual mode” with direct input from a human rider. For example, the electronic bicycle can autonomously navigate to a chosen destination where a rider is waiting. On arrival, the rider can place the electronic bicycle in manual mode and use it as a traditional bicycle. In some implementations, an electronic bicycle is a bicycle with two wheels, though an electronic bicycle can be any vehicle requiring lateral balance while in operation, such as a unicycle, recumbent bicycle, motorcycle, moped, or motor scooter. Additionally, while the description is predominantly within the context of an electronic bicycle, alternative embodiments may apply the principles described herein to other electronic vehicles, such as automobiles, trucks, all-terrain vehicles, motorcycles, segways, and scooters.

U.S. Pat. No. 10,754,340, entitled “Virtual Gearing in an Autonomous Electronic Bicycle” and issued Aug. 25, 2020, describes additional details regarding some example embodiments of an electronic bicycle. The contents of U.S. Pat. No. 10,754,340 are hereby incorporated by reference.

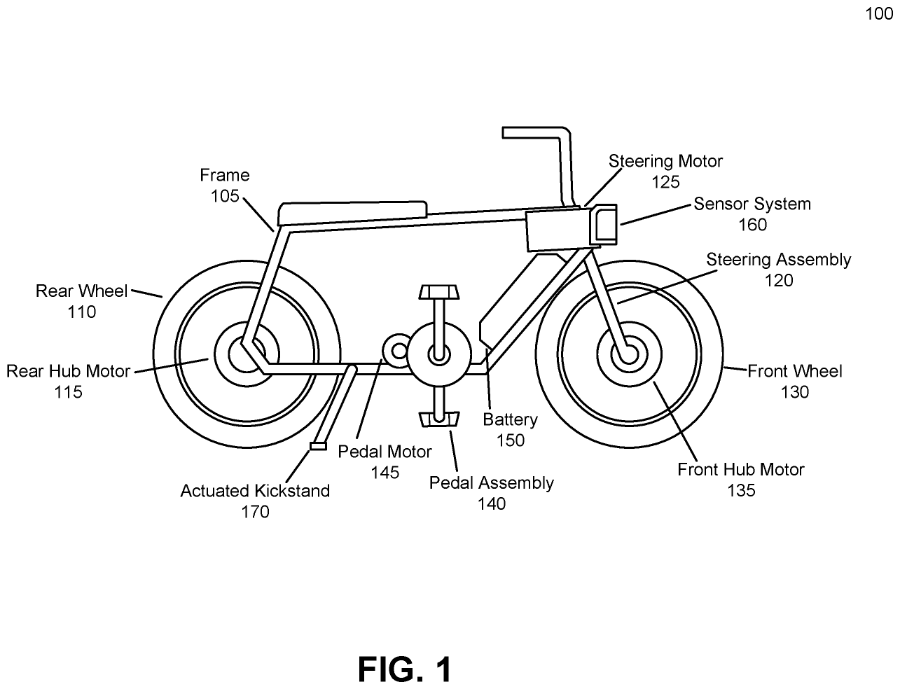

FIG. 1 illustrates example hardware components of an example electronic bicycle, in accordance with an embodiment. The electronic bicycle 100 of FIG. 1 comprises a frame 105, rear wheel 110, rear hub motor 115, steering assembly 120, steering motor 125, front wheel 130, front hub motor 135, pedal assembly 140, pedal motor 145, battery 150, sensor system 160, and kickstand 170. Alternative embodiments may include more, fewer, or different components from those illustrated in FIG. 1, and the structure or functionality of each component may be divided between the components differently from the description below. Additionally, each component may perform their respective functionalities in response to a request from a human, or automatically without human intervention.

The frame 105 of the electronic bicycle 100 can provide a base, platform, or frame for one or more components of the electronic bicycle 100 to attach to. In some embodiments, the frame 105 comprises a seat (or one or more seats) that can accommodate one or more riders of the electronic bicycle 100. The frame 105 can be made of aluminum, steel, carbon fiber, or any other suitable material or combination of materials formed by any suitable method.

In the embodiment of FIG. 1, the frame 105 comprises an attachment for the rear wheel 110 of the electronic bicycle 100. The rear wheel 110 can be made of any suitable materials, may be pneumatic, solid, or of any other suitable type, and can comprise a tire to provide traction on the ground surface. The rear wheel 110 is powered by the rear hub motor 115, which can be integrated into the hub or axle of the rear wheel 110. The rear hub motor 115 can be used to propel the electronic bicycle in a forward or reverse direction and/or to aid in balancing the electronic bicycle 100. The rear hub motor 115 can comprise one or more electric motors and can be geared or ungeared and use any suitable electronic motor technology, for example, the rear hub motor 115 can be a brushed or brushless DC motor, an AC motor, or of any other suitable type. In some implementations, the use of different types of electric motors can affect the final performance of the rear hub motor 115. For example, using an ungeared (or relatively ungeared) motor can allow the electronic bicycle 100 to better control the power applied through the rear hub motor 115, for example through the elimination of mechanical lash in the gearbox of a geared motor. However, ungeared motors may be less energy efficient than an equivalent geared motor.

In some embodiments, the rear hub motor 115 is additionally used to provide braking to the rear wheel 110. For example, the rear hub motor 115 use a regenerative braking system to return power to the battery 150 while providing braking force to the rear wheel 110. Similarly, the rear hub motor 115 can use a dynamic braking system, dissipating the excess energy to the frame, or, in emergency situations, through shorting the rear hub motor 115, according to some embodiments. Other embodiments of the rear wheel 110 can incorporate traditional mechanical brakes in place of or in addition to the use of the rear hub motor 115 as an electronic brake.

Further, in some embodiments, the rear hub motor 115 drives the rear hub of the rear wheel 110 without being integrated into the hub itself. For example, the rear hub motor 115 can drive the rear wheel 110 through a chain or belt drive (such as in a single gear traditional bicycle chain drive). In other embodiments, the rear hub motor 115 is integrated into the hub of the rear wheel 110, but the hub of the rear wheel 110 is also connected to the pedal assembly 140 through a chain or belt drive, for example, to allow a rider of the electronic bicycle 100 to provide mechanical power to the rear wheel 110 with or without the assistance of the rear hub motor 115 (such as in situations where the electronic bicycle 100 is manually operated by a rider.

The frame 105 can additionally be connected to a steering assembly 120, for example, a fork and handlebars enabling the front wheel 130 to be steered relative to the frame 105, in the embodiment of FIG. 1. In some implementations, the steering assembly 120 articulates relative to the frame 105 on one or more pivot points. The steering assembly 120 can be aluminum, steel, carbon fiber, or any other suitable material or combination of materials as described above. In some embodiments, the steering assembly 120 comprises handlebars or another suitable user control allowing a rider of the electronic bicycle 100 to control the steering angle of the front wheel 130 relative to the frame 105.

The steering assembly 120 can also be electronically controlled through the steering motor 125, which can articulate the steering assembly 120 (and therefore the front wheel 130) through a range of steering angles. The steering motor 125 can comprise one or more electric motors and can be geared or ungeared and use any suitable electronic motor technology, for example, the steering motor 125 can be a brushed or brushless DC motor, an AC motor, or of any other suitable type. In implementations where the electronic bicycle 100 is human-rideable, the steering motor 125 is configured to ensure that the steering assembly 120 remains a compliant actuator to user input. In some embodiments, the steering motor 125 is ungeared or minimally geared to minimize the drag provided to the steering assembly 120 when manually turned by a rider of the electronic bicycle 100. Similarly, the steering motor 125 can be intentionally oversized to improve low speed performance (as when turning the steering assembly 120) while ungeared. In some embodiments, the steering motor 125 is additionally used to actively damp the steering of the electronic bicycle 100 when ridden by a human rider. Similarly, some implementations use a “steer by wire” system for user control of the steering assembly 120. In a steer by wire implementation, the manual user controls for steering are not mechanically linked to the front wheel 130, so user steering input is measured and a proportional output is applied to the steering assembly 120 by the steering motor 125 to simulate a mechanical linkage.

The use of the steering motor 125 for active damping may enable the steering assembly 120 to be optimized for autonomous operation while maintaining rideability for a human rider. For example, the head angle (the angle of the head tube of the frame 105) of the steering assembly 120 and frame 105 can be steepened to provide additional responsiveness when operating autonomously, however, the steering motor 125 can be manually used to damp the steering of the electronic bicycle 100, simulating a slacker (more stable) head angle for a human rider.

The front wheel 130, like the rear wheel 110, can be any suitable material, size, and tire type, however, the front wheel 130 may be a different sizes or width than rear wheel 110. In some embodiments, the front wheel 130 is powered by the front hub motor 135. Similar to the rear hub motor 115 and the steering motor 125, the front hub motor 135 can comprise one or more electric motors and can be geared or ungeared and use any suitable electronic motor technology, for example, the front hub motor 135 can be a brushed or brushless DC motor, an AC motor, or of any other suitable type. In some embodiments, the front hub motor 135 and the steering motor 125 are the primary inputs used to control the balance of the electronic bicycle 100. Therefore, a responsive motor (such as an ungeared brushless DC motor) can be used for the front hub motor 135 to enable the electronic bicycle 100 to make fine adjustments to its balance/lean angle. Like the rear hub motor 115, the front hub motor 135 can be used for electronic braking as well (through dynamic braking, regenerative braking, or any suitable method as explained above), and/or the front wheel 130 may comprise a mechanical braking system.

The pedal assembly 140, according to some embodiments, allows a human rider of the electronic bicycle 100 to manually propel or otherwise provide power to the electronic bicycle 100. In some implementations, a virtual pedal system is used in which the pedal assembly 140 is not directly connected to the rear wheel 130 (e.g., via a chain). Instead, the pedal assembly 140 can be connected to the pedal motor 145, acting as a generator that the user can pedal against while generating power for the electronic bicycle 100. The resulting electrical power from the user's pedaling can be stored or used to power (or partially power) the electronic bicycle 100. In some embodiments, the rider of the electronic bicycle 100 can additionally or alternatively control the speed of the electronic bicycle 100 through a throttle or other speed control input. In these cases, the electronic bicycle 100 may not have the pedal assembly 140 or pedal motor 145. The pedal motor 145 can additionally be used to manipulate the pedal assembly 140 when in autonomous mode, for example, to avoid striking the pedals on obstacles when passing by in autonomous mode. In other embodiments, the pedal assembly 140 is connected mechanically to the rear wheel 130, for example with a chain or belt drive as described above.

The electronic bicycle 100 can comprise a battery 150 which can provide power to one or more components of the electronic bicycle 100, such as the front and rear hub motors 135 and 115 and the steering motor 125. The battery 150 can be a single battery or any suitable combination of batteries and/or other power storage devices (such as capacitors). In some embodiments, the battery 150 can send or receive power from one or more of the motors of the electronic bicycle 100, for example, from harvesting power from the pedal motor 145 (such, through the virtual pedal system), or from the front or rear wheel motor 115 and 135 through regenerative braking.

The electronic bicycle 100 can include a sensor system 160 including sensors capable of gathering information about the position of and environment around the electronic bicycle 100. The sensor system 160 can include any suitable sensor or suite of sensors and, although the sensor system 160 is represented as a single unit in FIG. 1, the sensors of the sensor system 160 can be located at any suitable position on the electronic bicycle 100 either grouped together or distributed in any suitable manner. For example, the sensor system 160 can comprise GPS sensors, gyroscopes or other orientation sensors, accelerometers, IMUs (Inertial Measurement Units), magnetometers, motion detectors, pedal and motor position sensors, SLAM (Simultaneous Localization and Mapping) or VSLAM (Visual Simultaneous Localization and Mapping) systems, depth sensors, curb feelers, and any other suitable sensors, each configured to produce a signal representative of a characteristic of the bicycle (such as a location of the bicycle, a position or orientation of the bicycle, a surrounding of the bicycle, and the like).

In some implementations, the electronic bicycle 100 can include an actuated kickstand 170 which may enable the bike to stop and start in autonomous mode without falling over. For example, the actuated kickstand 170 can comprise a linear actuator or electronic motor used to extend and retract the kickstand depending on the current situation. For example, the electronic bicycle 100 can retract the kickstand 170 in response to transitioning (or preparing to transition) from a stop to movement and can extend the kickstand 170 in response to transitioning from movement to a stop. In other embodiments, the electronic bicycle can use a track stand (a stationary two-wheel balance) to stop (for example, when waiting for short lengths of time at an intersection). Similarly, the electronic bicycle 100 can comprise other systems the electronic bicycle 100 in locomotion or balance, for example, a center of gravity shift mechanism allowing the electronic bicycle 100 to actively change the center of gravity to aid in balancing.

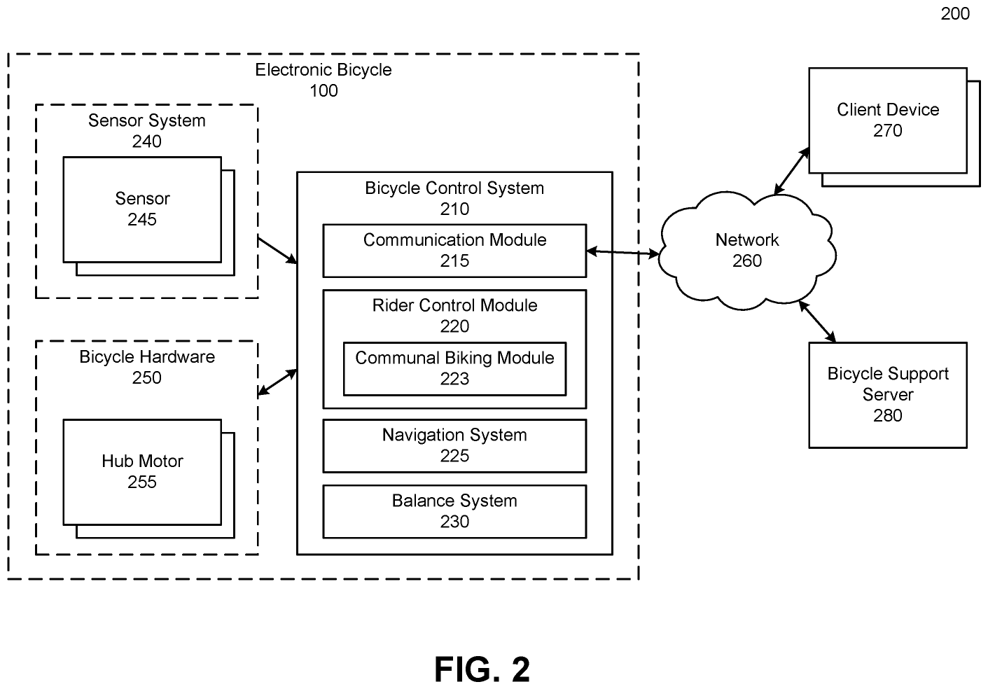

In some implementations, the electronic bicycle 100 is be controlled by a bicycle control system (or a controller or other processor of the bicycle) which can control one or more components of the electronic bicycle 100 based on input or signals from the sensor system 160, the pedal assembly 140, and/or communications with third parties or servers associated with the electronic bicycle 100. FIG. 2 is a block diagram of an environment in which an electronic bicycle operates, in accordance with an embodiment. The environment 200 of FIG. 2 comprises an electronic bicycle 205 communicatively connected one or more client devices 270 and the autonomous vehicle support server 280 over a network 260. Alternative embodiments may include more, fewer, or different components from those illustrated in FIG. 2, and the structure or functionality of each component may be divided between the components differently from the description below. Additionally, each component may perform their respective functionalities in response to a request from a human, or automatically without human intervention.

The electronic bicycle can be an electronic bicycle 100 as illustrated in FIG. 1 or any other suitable vehicle. In the embodiment of FIG. 2, the electronic bicycle 100 comprises a bicycle control system 210, a sensor system 240 comprising one or more sensors 245, and bicycle hardware 250 comprising one or more electronically controllable systems of the electronic bicycle 100, such as the hub motor 255, but which can also include any suitable motor, battery, actuator, or other system controlled by the bicycle control system 210.

The bicycle control system 210 can be any computer system, microcontroller, processor, mobile device, electronic circuit or system, or other suitable computing component mounted on the electronic bicycle 100 capable of operating the electronic bicycle 100. In the embodiment of FIG. 2, the bicycle control system 210 comprises a communication module 215, a rider control module 220, a navigation system 225, and a balance system 230.

In some implementations, the communication module 215 facilitates communications of the bicycle control system 210 over the network 260 using any suitable communication protocol. For example, the bicycle control system 210 can communicate with one or more client devices 270 over the network, for example to enable the electronic bicycle 100 to be controlled by a user of the client device 270, or for any other suitable reason. Similarly, the communication module 215 can communicate with the electronic bicycle support server 280 over the network 260. For example, the bicycle control system 210 can receive a destination for autonomous travel from the electronic bicycle support server 280.

In some embodiments, the communication module 215 of one electronic bicycle 100 communicates with communication modules 215 of other electronic bicycles 100. For example, a rider control module 220 may use the communication module 215 to communicate with other electronic bicycles 100 while the electronic bicycles 100 are engaged in a communal biking experience.

The rider control module 220 can, in some embodiments, control functions of the electronic bicycle 100 used when the electronic bicycle 100 is in manual mode. For example, the rider control module 220 can manipulate the bicycle hardware 250 to alter the handling characteristics of the electronic bicycle 100 to provide a better riding experience for a human rider. For example, the rider control module 220 can electronically damp rider steering inputs to simulate more stable riding characteristics than provided by the physical design of the electronic bicycle 100. For example, as described above, the steering motor 125 can be used to simulate a more stable steering response than natural based on the design of the electronic bicycle 100. Similarly, in implementations using steer by wire user steering controls, the rider control module 220 can magnify certain user steering inputs, or otherwise actively stabilize the electronic bicycle 100. Additionally, the rider control module 220 can power one or more of the front and rear hub motors 135 and 115 in response to user inputs to drive the electronic bicycle 100. For example, the rider control module 220 can output power proportional to a power output by a user through the pedal assembly 140 to one or more of the front and rear hub motors 135 and 115.

The rider control module 220 may include a communal biking module 223. A communal biking module 223 communicates with other electronic bicycles 100 so that riders on different electronic bicycles 100 can ride together and maintain communal biking experience. For example, the communal biking module 223 may adjust operational parameters of the electronic bicycle 100 such that a weaker rider is able to keep up with a stronger rider. Additionally, the communal biking module 223 may enforce certain operational restrictions on the electronic bicycle 100 so that a child rider does not stray too far away from a parent rider. The communal biking module 223 is described in further detail below.

In some implementations, the navigation system 225 and balance system 230 are active when the electronic bicycle 100 and the rider control module 220 is inactive while the electronic bicycle is in autonomous mode. Similarly, when the navigation system 225 and balance system 230 may be inactive when the electronic bicycle is in manual mode. In some embodiments, the rider control unit 220 can be used to control the electronic bicycle 100 remotely while in autonomous mode. For example, the electronic bicycle 100 can be remotely controlled (in some embodiments, by a user connected to the autonomous bicycle support server 280) to perform maneuvers the electronic bicycle 100 cannot perform autonomously (such as unprotected left turns across traffic).

The navigation system 225 can, in some embodiments, select a target pose for the electronic bicycle 100 to achieve. As used herein a “pose” of the electronic bicycle 100 represents a state of the electronic bicycle 100 at a specific time. For example, a pose of the electronic bicycle 100 can include a position of the frame 105 in 4D space (that is, an XYZ coordinate position and a time), a heading of the electronic bicycle 100, a heading rate (i.e., the speed at which the electronic bicycle 100 is turning), a velocity and/or acceleration of the electronic bicycle 100, a lean angle of the electronic bicycle 100, and any other suitable information about the state of the electronic bicycle. A pose can also include a relative or absolute position and/or orientation of one or more additional components of the electronic bicycle 100, for example an orientation of the front wheel 130 relative to the frame 105, or an angle of rotation of the pedal assembly 140. According to some implementations, the pose of the electronic bicycle 100 is measured relative to a point on the frame 105, and therefore does not account for any moving parts of the electronic bicycle 100 such as the front wheel 130 and the steering assembly 120, which may be, in these embodiments, measured relative to the position and orientation of the frame 105. In some embodiments, the pose of the electronic bicycle 100 is measured from a known origin point, for example, a point on the frame 105 of the electronic bicycle 100 or an external reference point such as a location destination, an external object or location within the vicinity of the electronic bicycle 100, or the like. In some implementations, a pose of the electronic bicycle 100 can be represented as a quaternion. According to some embodiments, the target pose determined by the navigation system 225 comprises a target heading rate and target velocity of the electronic bicycle 100.

In some embodiments, the navigation system 225 can select a target pose for the electronic bicycle 100 based on a determined destination and route to the destination, such as where the destination is a target point and the route is as set of high-level instructions to reach that point. For example, the destination can be a certain address and the route can be a series of streets and turns to follow when traveling to the address. In some implementations, the destination and/or the route is determined internally by the bicycle control system 210 or, in other implementations is provided by an external system. For example, the destination may be provided by a client device 270 or the electronic bicycle support server 280, and the route can be determined by the electronic bicycle support server 280 using a third-party service. The navigation system 225 will be discussed in further detail below.

The balance system 230 can, in some embodiments, take a target pose from the navigation system 225 and control the bicycle hardware 250 towards achieving the target pose while keeping the electronic bicycle 100 balanced. For example, the balance system 230 may set the output torque of one or more of the hub motors 115 and 135 and the steering motor 125 to move the electronic bicycle 100 through the target pose. In some implementations, the balance system 230 can modify a received target pose from the navigation system 225 (or generate a new target pose) to maintain the balance of the electronic bicycle 100. For example, the navigation system 225 can alter the target pose based on the current pose, the current acceleration, or any other factor that may impact the balance of the electronic bicycle 100.

The network 260, which may comprise any combination of local area and/or wide area networks, using both wired and/or wireless communication systems. In one embodiment, the network 260 uses standard communications technologies and/or protocols. For example, the network 260 can include communication links using technologies such as Ethernet, 3G, 4G, CDMA, WIFI, and Bluetooth. Data exchanged over the network 260 may be represented using any suitable format, such as hypertext markup language (HTML) or extensible markup language (XML). In some embodiments, all or some of the communication links of the network 260 may be encrypted using any suitable technique or techniques.

Each client device 270 can be a computing device capable of receiving user input as well as transmitting and/or receiving data via the network 260. In some embodiments, a client device 270 is a device having computer functionality, such as a mobile telephone, a smartphone, or another suitable device. In one embodiment, a client device 270 executes an application or web application allowing a user of the client device 270 to interact with the electronic bicycle 100 or the electronic bicycle support server 280. In another embodiment, a client device 270 interacts with the electronic bicycle 100 or the electronic bicycle support server 280 through an application programming interface (API) running on a native operating system of the client device 270. In some implementations, a user of the client device 270 can request use of an electronic bicycle 100 through an app or website over the network 260. Similarly, the destination can be a location provided by a potential rider through a mobile application running on a client device 270. In some implementations, an electronic bicycle 100 then autonomously drives itself to (or near to) the user of the client device 270 or another specified destination in autonomous mode. The user of the client device 270 can then place the electronic bicycle 100 in manual mode and ride the electronic bicycle 100 as needed.

The electronic bicycle support server 280 can any suitable server, server cluster, or cloud-based server capable of communication with and support of one or more electronic bicycles 100. In some embodiments, the electronic bicycle support server 280 can provide navigation instructions and/or route information. Similarly, the electronic bicycle support server 280 can provide object recognition processing or other functions of the navigation system 225 remotely, according to some embodiments. For example, when the additional lag introduced by sending data to the electronic bicycle support server 280 would not present safety concerns.

Inter-Bicycle Communication for Communal Biking Experiences

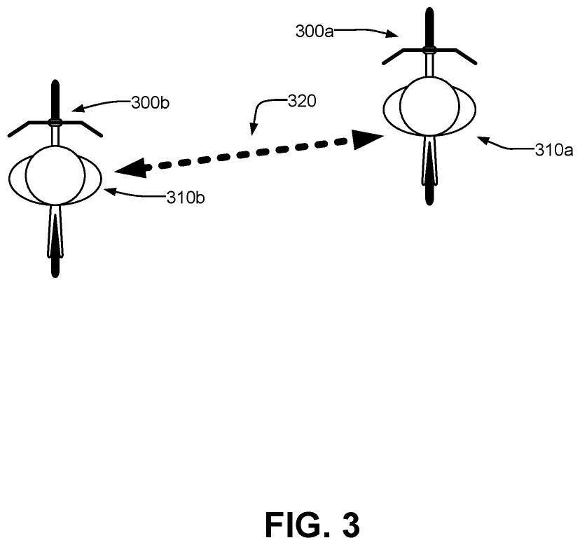

FIG. 3 illustrates electronic bicycles communicating to provide a communal biking experience for their riders, in accordance with some embodiments. FIG. 3 illustrates a primary electronic bicycle 300a ridden by a primary rider 310a and a secondary electronic bicycle 300b ridden by a secondary rider 310. However, electronic bicycles can communicate with any number of other electronic bicycles to provide a communal biking experience for any number of riders 310.

The electronic bicycles 300 provide for a communal biking experience by establishing a communicative connection 320 with each other. A communicative connection 320 is a connection between the electronic bicycles over a network that allows the electronic bicycles 300 to communicate with each other. For example, the electronic bicycles 300 may communicate through a LAN connection, a WAN connection, a Bluetooth connection, or an Ultra-Wide Band connection. In some embodiments, the network over which the electronic bicycles 300 establish the communicative connection 320 is a similar network to the network 260 illustrated in FIG. 2. The electronic bicycles 300 may establish a connection automatically or in response to a user input. In some embodiments, to establish the communicative connection 320 between electronic bicycles 300, a rider 310 identifies another rider's electronic bicycle 300 on a user interface of their own electronic bicycle 300.

The communicative connection 320 may additionally establish a primary electronic bicycle 300a and a secondary electronic bicycle 300b. The primary electronic bicycle 300a and the secondary electronic bicycle 300b may then control the communal biking experience using communications similar to a server-client model. For example, the primary electronic bicycle 300a may receive rider data from the secondary electronic bicycle 300b, determine operation parameters for both electronic bicycles 300, and transmit the operation parameters for the secondary electronic bicycle 300b to the secondary electronic bicycle 300b.

While the description herein may primarily describe the electronic bicycles 300 in terms of a primary electronic bicycle 300a and a secondary electronic bicycle 300b, alternative embodiments may deviate from this model. For example, the electronic bicycles 300 may both perform the functionalities of the primary electronic bicycle 300a or the secondary electronic bicycle 300b. Additionally, the electronic bicycles 300 may share rider data and jointly determine and adjust operation parameters for the electronic bicycles 300. Furthermore, the electronic bicycles 300 may share rider data with a separate device, such as a mobile device or a remote server, and that separate device may determine and adjust operation parameters for the electronic bicycles 300.

The electronic bicycles 300 collect rider data for their respective riders 310. Rider data is data describing a rider's operation of an electronic bicycle 300. For example, rider data may describe a rider's rate of pedaling, the speed or acceleration of the electronic bicycle while the rider has operated the electronic bicycle, how long the rider has operated the electronic bicycle during the rider's current session, the times and durations of when the rider has used the brakes of the electronic bicycle, the times and durations of when the rider has turned the handlebars on the electronic bicycle, the direction of the electronic bicycle, the orientation of the electronic bicycle, the weight of the rider, the weight of the electronic bicycle, or tire pressure of wheels of the electronic bicycle. Rider data also may include information about the environment in which the rider 310 is riding the electronic bicycle 300. For example, the rider data may include GPS data describing where the rider 310 has ridden the electronic bicycle 300, elevation data describing the elevation of the electronic bicycles 300, weather data at the location of the electronic bicycle, LIDAR data from an area around the electronic bicycle 300, or image data from an area around the electronic bicycle 300. The electronic bicycle 300 may receive rider data from a sensor on the electronic bicycle 300. For example, the electronic bicycle 300 may receive rider data from a LIDAR sensor, a radar sensor, a sonar sensor, a camera, a GPS tracking unit, a rotary encoder, a gyroscope, a pressure sensor, a barometer, or a thermometer.

The primary electronic bicycle 300a may receive rider data from both electronic bicycles 300 and may adjust output parameters for the electronic bicycles based on the received rider data. The output parameters for an electronic bicycle are parameters that control how user inputs are translated into an output. For example, the output parameters may include a virtual resistance, a virtual gear ratio, or an overall power output of the electronic bicycle. The primary electronic bicycle 300a may adjust the output parameters of an electronic bicycle by generating output adjustments for the output parameters. Output adjustments are adjustments to output parameters. Output adjustments may include increases or decreases to output parameters, such as increases or decreases to the virtual resistance of an electronic bicycle 300. The output adjustments also may adjust the output parameters to activate or deactivate certain features. For example, the output parameters may control steering assistance features of the electronic bicycle 300, and the output adjustments may adjust which of the features are active.

The primary electronic bicycle 300a may use output adjustments to adjust the output parameters of either electronic bicycle 300. For example, the primary electronic bicycle 300a may adjust output parameters for the primary electronic bicycle 300a directly. The primary electronic bicycle 300a also may transmit output adjustments to the secondary electronic bicycle 300b to adjust the output parameters of the secondary electronic bicycle 300b. In some embodiments, the primary electronic bicycle 300a continually receives rider data from the primary electronic bicycle 300a and the secondary electronic bicycle 300b and continually adjusts the output parameters for the electronic bicycles 300 based on the new rider data.

In some embodiments, the primary electronic bicycle 300a may identify one of the riders 310 as a weaker rider based on rider data received from the electronic bicycles. To identify the weaker rider, the primary electronic bicycle 300a may compare rider data from the primary electronic bicycle 300a and rider data from the secondary electronic bicycle 300b. The primary electronic bicycle 300a may then identify a weaker rider based on the comparison of the rider data. For example, the primary electronic bicycle 300a may compare the pedal rates of each of the riders 310 and may identify the rider that is pedaling more slowly as a weaker rider than the other rider. Similarly, the primary electronic bicycle 300a may compare the power output by each of the riders 310 to the pedals through pedal motors and may identify the rider with the lower power output as the weaker rider.

In some embodiments, the primary electronic bicycle 300a may identify a rider 310 as a weaker rider if the rider 310 based on the performances of the riders at the same or similar virtual resistances. The virtual resistance of an electronic bicycle 300 is a resistance that the electronic bicycle 300 applies to the pedals being turned by the rider. For example, the electronic bicycle 300 may apply a virtual resistance by applying a torque to the pedals using a pedal motor. The pedal motor may apply the torque by acting as a generator or dynamo and providing power back to a battery on the electronic bicycle 300 or may apply the torque by receiving power from the battery. The electronic bicycle 300 may apply a range of virtual resistances to the pedals.

In some embodiments, the electronic bicycle determines a virtual resistance to apply to the pedals based on a virtual gear ratio. A virtual gear ratio is a ratio of torque applied by a rider 310 to pedals to a torque output applied to the wheels. The virtual gear ratio can be set to simulate the feel of pedaling based on the current road conditions while in an appropriate gear. For example, the virtual gear ratio can account for the current incline and surface conditions of the road (for example, a traction or roughness of the road surface), the current pedal cadence of the rider, or a current speed of the electronic bicycle. U.S. patent '340, incorporated by reference above, contains further details on virtual resistances and virtual gear ratios used by electronic bicycles.

To identify a weaker rider, the primary electronic bicycle 300a may compare each rider's rate of pedaling at a particular virtual resistance or virtual gear ratio. The primary electronic bicycle 300a may then identify as the weaker rider the rider who pedals at the slower rate. In embodiments where the riders can select a virtual resistance, the primary electronic bicycle 300a may identify the rider 310 who selects a lower virtual resistance as the weaker rider.

The primary electronic bicycle 300a may adjust the output parameters for the weaker rider's electronic bicycle 300 to minimize a difference in the operation of the electronic bicycles 300. For example, the primary electronic bicycle 300a may adjust the output parameters of the weaker rider's electronic bicycle such that the weaker rider has a lower virtual resistance or a lower virtual gear ratio than the stronger rider's electronic bicycle. In some embodiments, the primary electronic bicycle 300a adjusts the output parameters of the weaker rider's electronic bicycle such that its power output is closer to the power output of the stronger rider's electronic bicycle. For example, the primary electronic bicycle 300a may compare the power output of the stronger rider's bicycle over a time period with the power output of the weaker rider's bicycle over the same time period. The primary electronic bicycle 300a may adjust output parameters of the weaker rider's electronic bicycle such that the weaker rider's operation of their electronic bicycle (e.g., their pedal rate) would correspond to a similar power output as the power output by the stronger rider's operation of their electronic bicycle. In some embodiments, the primary electronic bicycle 300a may adjust output parameters of the weaker rider's electronic bicycle such that the weaker rider's electronic bicycle maintains a similar speed to the stronger rider's electronic bicycle.

When adjusting output parameters of the electronic bicycles, the primary electronic bicycle 300a may adjust the output parameters of the weaker rider's electronic bicycle such that the electronic bicycle's operation remains responsive to the rider's input. For example, if the weaker rider has maintained a lower speed than the stronger rider, the primary electronic bicycle 300a may lower the virtual resistance for the weaker rider such that the weaker rider has pedal more quickly. When the weaker rider pedals more quickly due to the lower virtual resistance, the weaker rider's electronic bicycle may accelerate with the increased pedal rate. Thus, the weaker rider's speed increases while their electronic bicycle maintains a simulated biking experience.

In some embodiments, the primary electronic bicycle 300a adjusts the output parameters of the weaker rider's electronic bicycle based on a distance between the electronic bicycles. For example, the primary electronic bicycle 300a may determine a distance between the electronic bicycles. The primary electronic bicycle 300a may determine the distance between the electronic bicycles based on GPS data, Bluetooth data, or ultra-wide band data. The primary electronic bicycle 300a may adjust the output parameters of the weaker rider's bicycle based on the determined distance between the electronic bicycles. For example, when the weaker rider's bicycle as the distance between the electronic bicycles is large or increases, the primary electronic bicycle 300a may apply greater adjustments to the output parameters of the weaker rider's electronic bicycle. Similarly, the primary electronic bicycle 300a may apply smaller adjustments to the output parameters of the weaker rider's electronic bicycle when the distance between the electronic bicycles is small or decreases.

In some embodiments, the output parameters for an electronic bicycle 300 include a steering aid parameter that determines an amount of autonomous steering aid the electronic bicycle provides to the rider. For example, if the steering aid parameter for a rider is low, then the electronic bicycle 300 may provide little or no steering aid to the rider, and the rider may have full control over steering the electronic bicycle 300. If the steering aid parameter is high, then the electronic bicycle 300 may provide significant assistance to the rider in steering the electronic bicycle 300. For example, the electronic bicycle 300 may detect that the rider is likely to fall off of the electronic bicycle 300 and may automatically adjust the steering mechanism of the electronic bicycle 300 to prevent the rider from falling off. Similarly, the electronic bicycle 300 may detect that the rider is deviating from an intended path and may automatically steer the electronic bicycle onto the correct path. The electronic bicycle 300 may provide the steering assistance through components that the electronic bicycle 300 uses in autonomous navigation. In some embodiments, the steering aid parameter determines which of a set of steering aid features of the electronic bicycle 300 are active.

The electronic bicycle 300 may adjust the steering aid parameter for a weaker rider's electronic bicycle. For example, the weaker rider's electronic bicycle 300 may detect when the weaker rider's electronic bicycle is steering away from the stronger rider's electronic bicycle and may automatically steer the weaker rider back towards the stronger rider's electronic bicycle 300. Similarly, the weaker rider's electronic bicycle may provide steering assistance to the weaker rider to maintain a lateral distance between the electronic bicycles 300. For example, the weaker rider's electronic bicycle may determine a distance between the electronic bicycles 300 and, if the distance between the electronic bicycles 300 exceeds a maximum, the weaker rider's electronic bicycle may automatically steer to reduce the distance between the electronic bicycles 300.

In some embodiments, instead of or in addition to adjusting the output parameters of the weaker rider's electronic bicycle, the primary electronic bicycle 300a adjusts the output parameters of the stronger rider's electronic bicycle based on the rider data of the riders. For example, the primary electronic bicycle 300a may adjust the output parameters of the stronger rider's electronic bicycle to reduce the speed of the stronger rider's electronic bicycle, increase the virtual resistance, or raise the gear ratio of the stronger rider's electronic bicycle.

The primary electronic bicycle 300a also may adjust the output parameters of the secondary electronic bicycle 300b based on rider restrictions set by a rider. For example, a parent riding the primary electronic bicycle 300a may establish restrictions for a child riding the secondary electronic bicycle 300b. The rider restrictions are restrictions or limitations that a rider can place on the operation of an electronic bicycle 300. For example, the rider restrictions may limit the speed of an electronic bicycle 300 or may limit the geographic area within which the electronic bicycle 300 can be ridden. The primary electronic bicycle 300a may enforce rider restrictions by adjusting the power output of the electronic bicycle 300, the virtual resistance, or the virtual gear ratio.

In some embodiments, the rider restrictions limit the output parameters of the secondary electronic bicycle 300b based on a distance between the primary electronic bicycle 300a and the secondary electronic bicycle 300b. For example, the rider of the primary electronic bicycle 300a may establish a maximum distance that the secondary electronic bicycle 300b can be from the primary electronic bicycle 300a. The primary electronic bicycle 300a may therefore reduce the ability of the secondary electronic bicycle 300b to travel ahead of the primary electronic bicycle 300a, e.g., by increasing virtual resistance, increasing the virtual gear ratio, or decreasing the power output as the secondary electronic bicycle 300b approaches the maximum distance away from the primary electronic bicycle 300a. In some embodiments, the secondary electronic bicycle 300b may autonomously steer the rider of the secondary electronic bicycle 300b back towards the primary electronic bicycle 300a if the secondary electronic bicycle 300b has exceeded the maximum distance.

The rider restrictions also may limit the output parameters of the secondary electronic bicycle 300b based on the environment in which the electronic bicycles 300 are riding. For example, the rider restrictions may limit the speed of the secondary electronic bicycle 300b when the electronic bicycles are in a dangerous environment (e.g., when biking in the street or on a steep hill). Similarly, the rider restrictions may reduce a maximum distance that the secondary electronic bicycle 300b can be from the primary electronic bicycle 300a when the electronic bicycles are in a dangerous environment. Furthermore, the electronic bicycles may detect objects in the environment and the rider restrictions may additionally limit the output parameters based on the detected objects. For example, the rider restrictions may adjust the output parameters of the secondary electronic bicycle 300b such that the secondary electronic bicycle 300b steers closer to a curb in response to detecting a car in the environment. Additionally, the electronic bicycles may detect a street, a stop sign, or a stop light, and the rider restrictions may adjust the output parameters such that the secondary electronic bicycle 300b cannot cross the street without the primary electronic bicycle 300a being nearby in response to detecting one of those objects.

In some embodiments, the primary electronic bicycle 300a sets a maximum speed for both electronic bicycles. For example, the primary electronic bicycle 300a may not change the output parameters for the electronic bicycles 300 when the electronic bicycles 300 are traveling below the maximum speed. However, when one of the electronic bicycles 300 approaches or exceeds the maximum speed, the primary electronic bicycle 300a may adjust the output parameters for that bicycle such that it is more difficult for that rider to accelerate further. For example, the primary electronic bicycle 300a may increase the virtual resistance or the gear ratio, or may decrease the power output, as an electronic bicycle approaches or exceeds a maximum speed. Similarly, the primary electronic bicycle 300a may apply brakes to reduce the speed of an electronic bicycle 300 that is exceeding the maximum speed.

In some embodiments, the maximum speed is a predetermined speed set by a rider. For example, a rider may establish a maximum speed for both electronic bicycles 300. The rider may provide the maximum speed through an application operating on a client device or through a user interface of an electronic bicycle 300. The primary electronic bicycle 300a may enforce the predetermined maximum speed while the electronic bicycles 300 are in operation. In some embodiments, the primary electronic bicycle 300a adjusts the maximum speed based on the speed of the primary electronic bicycle 300a. For example, the primary electronic bicycle 300a may adjust the output parameters for the secondary electronic bicycle 300b such that the secondary electronic bicycle 300b does not exceed the speed of the primary electronic bicycle 300a.

In some embodiments, the electronic bicycles are set to travel at a fixed speed or provide a fixed power output while both riders 310 are riding the electronic bicycles 300. The riders 310 may then continue to pedal, but the rate at which the riders 310 pedal may not impact the speed at which their electronic bicycle travels. In some embodiments, the rider with the greater pedal rate sets the speed for both electronic bicycles. For example, if the rider of the primary electronic bicycle 300a is pedaling faster than the rider of the secondary electronic bicycle 300b, then the speed of both electronic bicycles may be set based on the pedaling of the rider of the primary electronic bicycle 300a. If the rider of the secondary electronic bicycle 300b starts pedaling faster than the rider of the primary electronic bicycle 300a, then the speed of both electronic bicycles may be set based on the pedaling of the rider of the secondary electronic bicycle 300b.

In some embodiments, the primary electronic bicycle 300a adjusts the output parameters of the secondary electronic bicycle 300b to mimic a riding experience of the rider 310a of the primary electronic bicycle 300a. For example, if the rider 310a of the primary electronic bicycle 300a is riding in a different location from the rider 310b of the secondary electronic bicycle 300b, then the primary electronic bicycle 300a may adjust the output parameters of the secondary electronic bicycle 300b to mimic the operation of the primary electronic bicycle 300a. Similarly, the primary electronic bicycle 300a may receive rider data from the secondary electronic bicycle 300b and may adjust the output parameters of the primary electronic bicycle 300a to mimic the riding experience of the secondary electronic bicycle 300b.

In some embodiments, the primary electronic bicycle 300a mimics the riding experience of an electronic bicycle 300 by replicating the output parameters of the electronic bicycle 300 on another electronic bicycle. For example, the primary electronic bicycle 300a may adjust output parameters to mimic the riding experience of one of the electronic bicycles 300 by mimicking the virtual resistance of the other electronic bicycle 300. For example, the secondary electronic bicycle 300b may determine that the secondary electronic bicycle 300b is climbing up an incline, and the secondary electronic bicycle 300b may accordingly increase the virtual resistance to simulate the incline. The primary electronic bicycle 300a may receive rider data describing the increased virtual resistance and may similarly raise the virtual resistance of the primary electronic bicycle 300a. The primary electronic bicycle 300a may continually update the output parameters of an electronic bicycle 300 to replicate the output parameters of another electronic bicycle 300 as the output parameters of the other electronic bicycle 300 changes.

In some embodiments, an electronic bicycle adjusts its output parameters without establishing a communicative connection with another electronic bicycle. For example, a rider may instruct the electronic bicycle to require the rider to provide a minimum power output at all times so that the rider can effectively exercise on the electronic bicycle regardless of the terrain. Additionally, a rider may instruct the electronic bicycle to enforce certain restrictions on its operation. This may allow a parent to enforce restrictions on a child's operation of the electronic bicycle. The electronic bicycle may adjust its output parameters based on the instructions received from the rider. For example, the electronic bicycle may automatically adjust a virtual resistance of the electronic bicycle to ensure that a rider maintains a specified power output. Similarly, the electronic bicycle may increase the virtual resistance of the electronic bicycle or even brake the electronic bicycle to enforce a maximum speed limit set for the electronic bicycle. The rider, or another person, can provide instructions to the electronic bicycle through a user interface of a client device or through a user interface of the electronic bicycle.

Example Method for Adjusting Output Parameters for Weaker Rider

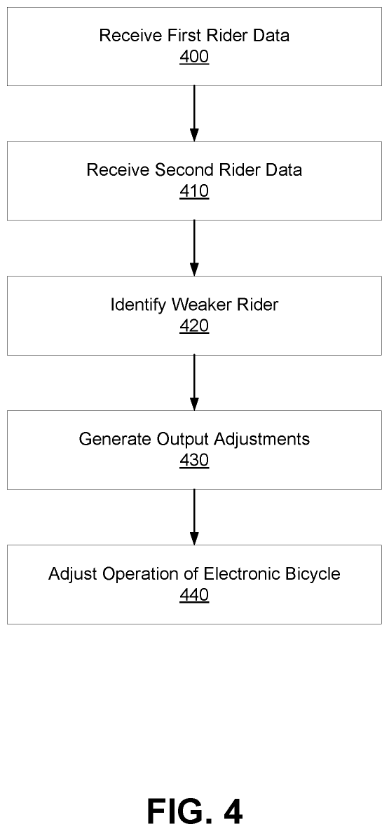

FIG. 4 is a flowchart illustrating an example method for adjusting output parameters of a weaker rider's electronic bicycle, in accordance with some embodiments. Alternative embodiments may include more, fewer, or different steps and the steps may be performed in an order different from that illustrated in FIG. 4. Additionally, the steps may be performed automatically or in response to a human instruction. Furthermore, while the steps below are described as being performed by a first electronic bicycle, alternative embodiments may have the steps performed by the second electronic bicycle or a separate device, like a remote server or a mobile device.

A first electronic bicycle receives 400 first rider data describing an operation of the first electronic bicycle by a first rider. The first electronic bicycle also receives 410 second rider data from a second electronic bicycle that is communicatively connected to the first electronic bicycle. The second rider data describes an operation of the second electronic bicycle by a second rider.

The first electronic bicycle identifies 420 a weaker rider based on the first rider data and the second rider data. The first electronic bicycle may identify a weaker rider by comparing the first rider's operation of the first electronic bicycle with the second rider's operation of the second electronic bicycle. For example, the first electronic bicycle may identify as the weaker rider the rider who generates less power through pedaling the pedals of their respective electronic bicycle. The first electronic bicycle also may identify as the weaker rider the rider who pedals more slowly. The first electronic bicycle may identify the first rider as the weaker rider or the second rider as the weaker rider.

The first electronic bicycle generates 430 a set of output adjustments for the electronic bicycle of the weaker rider. The set of output adjustments are adjustments to be made to the output parameters of the weaker rider's electronic bicycle to minimize a difference between the operations of the first electronic bicycle by the first rider and the operation of the second electronic bicycle by the second rider. The first electronic bicycle generates the set of output adjustments based on the first rider data and the second rider data. For example, the output adjustments may increase a power output by the weaker rider's electronic bicycle such that it outputs a power more similar to the stronger rider's electronic bicycle.

The first electronic bicycle adjusts 440 the operation of the weaker rider's electronic bicycle based on the output adjustments. If the first rider is the weaker rider, the first electronic bicycle adjusts its own output parameters directly based on the output adjustments. If the second rider is the weaker rider, then the first electronic bicycle may transmit the output adjustments to the second electronic bicycle and the second electronic bicycle may adjust its output parameters based on the output adjustments.

Example Method for Enforcing Rider Restrictions

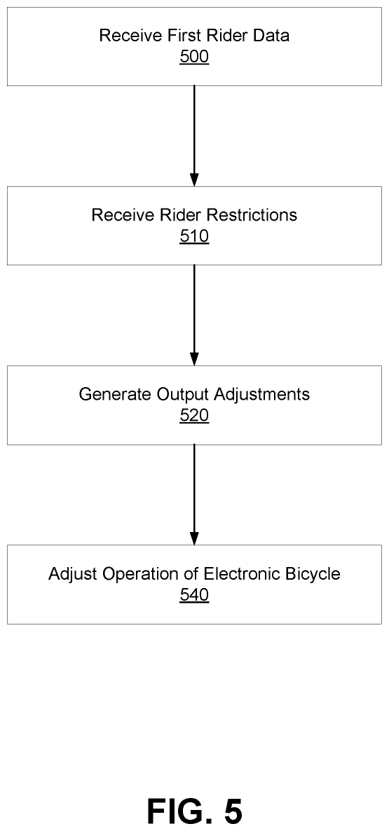

FIG. 5 is a flowchart illustrating an example method for enforcing rider restrictions on an electronic bicycle, in accordance with some embodiments. Alternative embodiments may include more, fewer, or different steps and the steps may be performed in an order different from that illustrated in FIG. 5. Additionally, the steps may be performed automatically or in response to a human instruction. Furthermore, while the steps below are described as being performed by a first electronic bicycle, alternative embodiments may have the steps performed by the second electronic bicycle or a separate device, like a remote server or a mobile device.

A first electronic bicycle receives 500 first rider data describing a first rider's operation of the first electronic bicycle. The first electronic bicycle may also receive second rider data describing a second rider's operation of a second electronic bicycle. The first electronic bicycle receives 510 a set of rider restrictions from the first rider. The set of rider restrictions are restrictions on the operation of the second electronic bicycle. For example, the rider restrictions may limit the second electronic bicycle to a maximum speed limit or may limit the second electronic bicycle to operating within a maximum distance of the first electronic bicycle.

The first electronic bicycle generates 520 a set of output adjustments for the second electronic bicycle. The set of output adjustments are adjustments to be made to the output parameters of the second electronic bicycle to enforce the received rider restrictions. The first electronic bicycle generates the set of output adjustments based on the first rider data and the second rider data. For example, the output adjustments may decrease a power output by the second electronic bicycle when the second electronic bicycle approaches or exceeds a maximum speed in the rider restrictions or as the second electronic bicycle approaches or exceeds a maximum distance from the first electronic bicycle.

The first electronic bicycle adjusts 440 the operation of the second electronic bicycle based on the output adjustments. The first electronic bicycle may transmit the output adjustments to the second electronic bicycle and the second electronic bicycle may adjust its output parameters based on the output adjustments.

### CONCLUSION

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A non-transitory computer-readable medium storing instructions that, when executed by a processor, cause the processor to:
receive first rider data from a first electronic bicycle, wherein the first rider data describes an operation of the first electronic bicycle by the first rider;
receive second rider data from a second electronic bicycle, wherein the second electronic bicycle is communicatively connected to the first electronic bicycle, and wherein the second rider data describes an operation of the second electronic bicycle by the second rider;
identify the second rider as a weaker rider based on the first rider data and the second rider data;
responsive to identifying the second rider as the weaker rider, generate a set of output adjustments for the second electronic bicycle based on the first rider data and the second rider data, wherein the set of output adjustments comprise an adjustment to an output parameter of the second electronic bicycle, and wherein the set of output adjustments are generated to minimize a difference between the operation of the first electronic bicycle and the operation of the second electronic bicycle; and
adjust the operation of the second electronic bicycle based on the set of output adjustments.

2. The computer-readable medium of claim 1, further comprising instructions that, when executed by the processor, cause the processor to establish a communicative connection between the first electronic bicycle and the second electronic bicycle over a network.

3. The computer-readable medium of claim 2, wherein the network comprises at least one of a wide-area network, a local network, a Bluetooth connection, or an ultra-wide band connection.

4. The computer-readable medium of claim 1, wherein the second rider data is received by the first electronic bicycle from the second electronic bicycle, and wherein adjusting the operation of the second electronic bicycle comprises transmitting, by the first electronic bicycle, the set of output adjustments to the second electronic bicycle.

5. The computer-readable medium of claim 1, wherein the first rider data is received by the second electronic bicycle from the first electronic bicycle.

6. The computer-readable medium of claim 1, wherein the first rider data and the second rider data are received by a remote server.

7. The computer-readable medium of claim 1, wherein identifying the second rider as a weaker rider comprises comparing the operation of the first electronic bicycle by the first rider with the operation of the second electronic bicycle by the second rider.

8. The computer-readable medium of claim 1, wherein comparing the operation of the first electronic bicycle with the operation of the second electronic bicycle comprises comparing a pedal rate of the first rider with a pedal rate of the second rider.

9. The computer-readable medium of claim 1, wherein comparing the operation of the first electronic bicycle with the operation of the second electronic bicycle comprises comparing a power output by the first rider to pedals of the first electronic bicycle with a power output by the second rider to pedals of the second electronic bicycle.

10. The computer-readable medium of claim 1, wherein the set of adjustments comprise an adjustment to at least one of a virtual resistance of the second electronic bicycle, a virtual gear ratio of the second electronic bicycle, or a power output by a motor that rotates a wheel of the second electronic bicycle.

11. A method comprising:
receiving first rider data from a first electronic bicycle, wherein the first rider data describes an operation of the first electronic bicycle by the first rider;
receiving second rider data from a second electronic bicycle, wherein the second electronic bicycle is communicatively connected to the first electronic bicycle, and wherein the second rider data describes an operation of the second electronic bicycle by the second rider;
identifying the second rider as a weaker rider based on the first rider data and the second rider data;
responsive to identifying the second rider as the weaker rider, generating a set of output adjustments for the second electronic bicycle based on the first rider data and the second rider data, wherein the set of output adjustments comprise an adjustment to an output parameter of the second electronic bicycle, and wherein the set of output adjustments are generated to minimize a difference between the operation of the first electronic bicycle and the operation of the second electronic bicycle; and
adjusting the operation of the second electronic bicycle based on the set of output adjustments.

12. The method of claim 11, further comprising establishing a communicative connection between the first electronic bicycle and the second electronic bicycle over a network.

13. The method of claim 12, wherein the network comprises at least one of a wide-area network, a local network, a Bluetooth connection, or an ultra-wide band connection.

14. The method of claim 11, wherein the second rider data is received by the first electronic bicycle from the second electronic bicycle, and wherein adjusting the operation of the second electronic bicycle comprises transmitting, by the first electronic bicycle, the set of output adjustments to the second electronic bicycle.

15. The method of claim 11, wherein the first rider data is received by the second electronic bicycle from the first electronic bicycle.

16. The method of claim 11, wherein the first rider data and the second rider data are received by a remote server.

17. The method of claim 11, wherein identifying the second rider as a weaker rider comprises comparing the operation of the first electronic bicycle by the first rider with the operation of the second electronic bicycle by the second rider.

18. The method of claim 11, wherein comparing the operation of the first electronic bicycle with the operation of the second electronic bicycle comprises comparing a pedal rate of the first rider with a pedal rate of the second rider.

19. The method of claim 11, wherein comparing the operation of the first electronic bicycle with the operation of the second electronic bicycle comprises comparing a power output by the first rider to pedals of the first electronic bicycle with a power output by the second rider to pedals of the second electronic bicycle.

20. The method of claim 11, wherein the set of adjustments comprise an adjustment to at least one of a virtual resistance of the second electronic bicycle, a virtual gear ratio of the second electronic bicycle, or a power output by a motor that rotates a wheel of the second electronic bicycle.
